(19) United States
(12) Patent Application Publication
(10) Pub. No.: US 2009/0244281 A1
(43) Pub. Date: Oct. 1, 2009

(54) MONITORING APPARATUS AND DISPLAY PROCESSING METHOD FOR THE MONITORING APPARATUS

(75) Inventor: Kiichi Hiromasa, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/404,239

(22) Filed: Mar. 13, 2009

(30) Foreign Application Priority Data
Mar. 26, 2008 (JP) 2008-080847

(51) Int. Cl. H04N 7/18

(52) U.S. Cl. 348/143; 348/E07.085

(57) ABSTRACT

A monitoring apparatus causes a display unit to display an image of a monitor target at entering a room together with an image of the monitor target at exiting the room transmitted from an image capturing apparatus corresponding to a gate terminal apparatus.

### BACKGROUND OF THE INVENTION

1. Field of the Invention

The present invention relates to a monitoring apparatus that monitors images of a person at entering a room and exiting the room.

2. Description of the Related Art

Conventionally, in a monitoring system that performs monitoring with an installed image capturing apparatus, generally, an image captured by the image capturing apparatus is displayed on a display apparatus, and an observer visually checks occurrence of abnormal state.

Japanese Patent Application Laid-Open No. 8-111859 discusses a system that allows past information about a communication destination to be superimposed and displayed on a screen displaying current information about the destination.

However, in the system discussed in Japanese Patent Application Laid-Open No. 8-111859, with respect to the past information to be superimposed on the current information, the user has to search and acquire the past information. Accordingly, in a case where the observer views, while monitoring an image of a person who exits a room, an image of the person captured at entry, first, the observer has to recognize who the person is, and then, perform the search.

### SUMMARY OF THE INVENTION

The present invention is directed to a monitoring apparatus configured to display not only an image of a monitor target who exits a monitoring area but an image of the monitor target at entering the monitoring area in a case where the image of the monitor target at exit is viewed.

According to an aspect of the present invention, a monitoring apparatus includes a reception unit configured to receive identification information of a monitor target exiting a room through a gate from a gate terminal apparatus, an acquisition unit configured to acquire an image of the monitor target captured at entry from a storage unit based on the identification information of the monitor target received by the reception unit, and a processing unit configured to cause a display unit to display the image of the monitor target at entry acquired by the acquisition unit together with an image of the monitor target at exit transmitted from an image capturing apparatus corresponding to the gate terminal apparatus.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a view illustrating a configuration of a monitoring system according to a first exemplary embodiment of the present invention.

FIG. 2 is a view illustrating an example of the layout of components of the monitoring system according to the first exemplary embodiment of the present invention.

FIG. 3 is a view illustrating an example of management information (management table 1) indicating relationships among gate terminal apparatuses, gates, monitoring areas, entry/exit flags, and image capturing apparatuses.

FIG. 4 is a view illustrating an example of management information (entry/exit record and image table) indicating relationships among monitor targets, gates, monitoring areas, entry/exit flags, time of passage, indexes of images at entry/exit, and states of monitor targets.

FIG. 5 is a view illustrating an example of an entry/exit record and image table after a monitor target P4 enters a room.

FIG. 6 is a flowchart illustrating operational processing performed by a monitor terminal apparatus according to the first exemplary embodiment of the present invention.

FIG. 7 is a view illustrating an example of a screen of a display unit displaying a current image and a map according to the first exemplary embodiment of the present invention.

FIG. 8 is a view illustrating an example of a screen of the display unit displaying gate positions on a map according to the first exemplary embodiment of the present invention.

FIG. 9 is a view illustrating an example of a screen of the display unit displaying an image at entry and an image at exit according to the first exemplary embodiment of the present invention.

FIG. 10 is a flowchart illustrating operational processing performed by a monitor terminal apparatus according to a second exemplary embodiment of the present invention.

FIG. 11 is a view illustrating an example of entry/exit information (entry/exit information correspondence table).

FIG. 12 is a view illustrating an example of a screen of a display unit during image reproduction according to the second exemplary embodiment of the present invention.

FIG. 13 is a view illustrating an example of an image at entry displayed during image reproduction according to the second exemplary embodiment of the present invention.

### DETAILED DESCRIPTION OF THE EMBODIMENTS

Various exemplary embodiments, features, and aspects of the invention will be described in detail below with reference to the drawings.

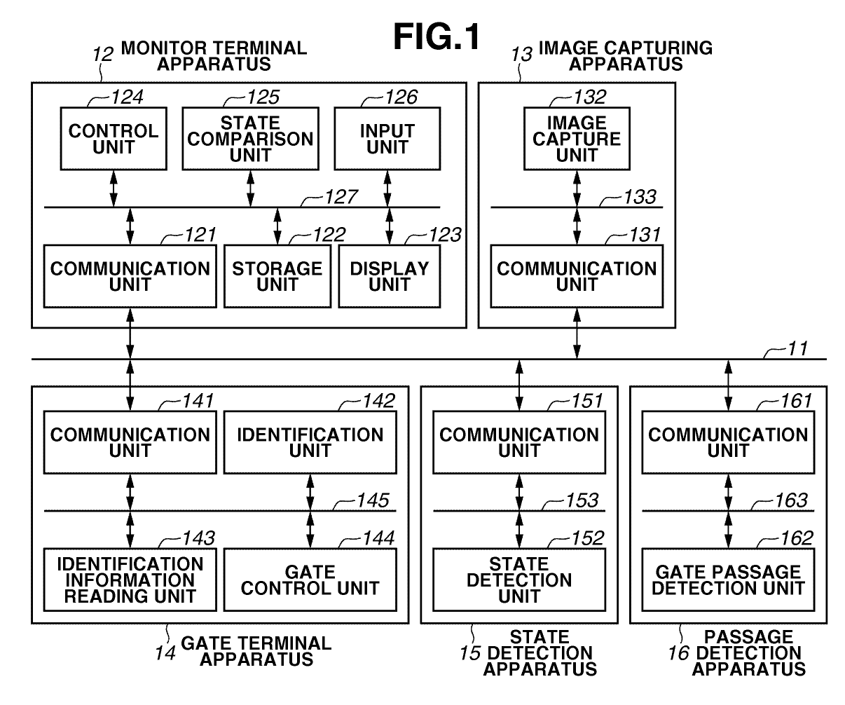

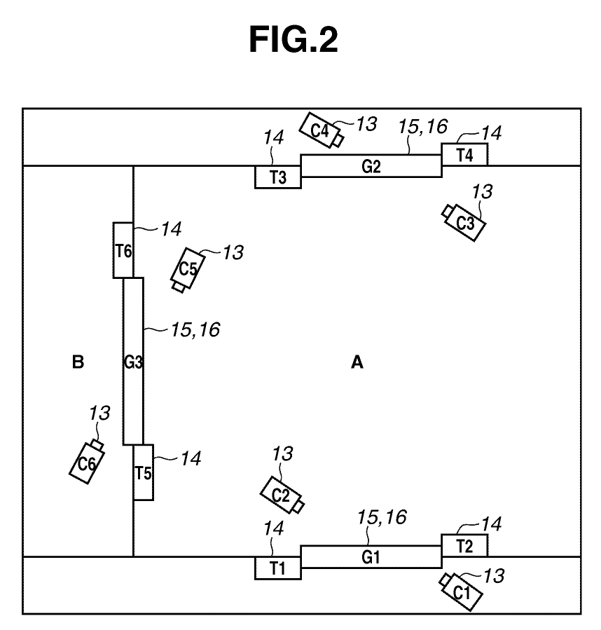

FIG. 1 is a view illustrating a configuration of a monitoring system according to a first exemplary embodiment of the present invention. FIG. 2 is a view illustrating an example of the layout of components of the monitoring system in FIG. 1 in a monitoring area.

As illustrated in FIG. 1, the monitoring system according to the first exemplary embodiment includes a network 11, a monitor terminal apparatus 12, which functions as a monitoring apparatus, an image capturing apparatus 13, a gate terminal apparatus 14, a state detection apparatus 15, and a passage detection apparatus 16.

In FIG. 2, six image capturing apparatuses 13 are shown with identification names C1 to C6. Similarly, six gate terminal apparatuses 14 are shown with identification names T1 to T6. Three gates are shown with identification names G1 to G3. On each of the gates G1 to G3, the state detection apparatus 15, which detects a state of a monitor target, and the passage detection apparatus 16, which detects a monitor target passing through the gate, are mounted. The monitoring area is shown with identification name A or B. The monitoring area B is located such that a monitor target can first enter the monitoring area A and, then, enter the monitoring area B through the gate G3. The monitoring area A is located such that a monitor target can enter the monitoring area A through the gate G1 or the gate G2.

The image capturing apparatus C1 is associated with the gate terminal apparatus T2 and the gate G1. The image capturing apparatus C2 is associated with the gate terminal apparatus T1 and the gate G1. Similarly, the image capturing apparatus C3 is associated with the gate terminal apparatus T4 and the gate G2. The image capturing apparatus C4 is associated with the gate terminal apparatus T3 and the gate G2. The image capturing apparatus C5 is associated with the gate terminal apparatus T6 and the gate G3. The image capturing apparatus C6 is associated with the gate terminal apparatus T5 and the gate G3.

In FIG. 1, the image capturing apparatuses 13 (C1 to C6) and the gate terminal apparatuses 14 (T1 to T6) are connected to the network 11. Further, the state detection apparatuses 15 and the passage detection apparatuses 16 that are mounted on the gates G1 to G3 are connected to the network 11.

In the present exemplary embodiment, it is assumed that the network 11 employs a TCP/IP network. Accordingly, it is possible to use the Internet, a local area network (LAN), or the like. The communication protocol is not limited to TCP/IP, but any protocol that performs a similar function can be employed. With respect to the line, if the above-described protocols can be used, any line, for example, a wired line or a radio wave can be employed.

As illustrated in FIG. 1, the monitor terminal apparatus 12 includes a communication unit 121, a storage unit 122, a display unit 123, a control unit 124, a state comparison unit 125, an input unit 126, and a bus 127. The communication unit 121, the storage unit 122, the display unit 123, the control unit 124, the state comparison unit 125, and the input unit 126 are connected to the bus 127. The communication unit 121 is connected to the network 11. The storage unit 122 is configured with computer-readable memories such as a hard disk (HD) and a random access memory (RAM). In the exemplary embodiment, in the hard disk of the storage unit 122, a program for implementing processing by the monitor terminal apparatus 12 is stored. The RAM is used as a memory for temporarily storing a read program and the like. The control unit 124 and the state comparison unit 125 can be configured with a central processing unit (CPU) or independent processors.

The image capturing apparatus 13 includes a communication unit 131, which transfers an image to the outside, an image capture unit 132, which has an image sensor, and a bus 133. The communication unit 131 and the image capture unit 132 are connected to the bus 133. The communication unit 131 is connected to the network 11.

In FIG. 2, the image capturing apparatuses 13 (C1 and C2) perform image capturing of a monitor target who enters or exits the room through the gate G1, and acquire an image at entry and an image at exit. Similarly, the image capturing apparatuses 13 (C3 and C4) and the image capturing apparatuses 13 (C5 and C6) perform image capturing of a monitor target who enters or exits the room through the gates G2 and G3, respectively, and acquire an image at entry and an image at exit.

The images captured by the image capturing apparatuses 13 (C1 to C6) are stored in the hard disk of the storage unit 122.

The gate terminal apparatus 14 includes a communication unit 141, an identification 142, an identification information reading unit 143, a gate control unit 144, and a bus 145. The communication unit 141, the identification unit 142, the identification information reading unit 143, and the gate control unit 144 are connected to the bus 145. The communication unit 141 is connected to the network 11. For example, in FIG. 2, the gate terminal apparatus 14 (T1 and T2) identify a monitor target who enters or exits the room through the gate G1, respectively.

The identification information of the monitor target read by the identification information reading units 143 in the gate terminal apparatuses 14 (T1 to T6) or the identification information, such as a name of the monitor target, identified by the identification units 142 in the gate terminal apparatuses 14 (T1 to T6) is transmitted to the monitor terminal apparatus 12.

The identification information reading unit 143 can be configured with an identification (ID) card reader, or a biological information reader for reading a face image, a fingerprint, a vein, or an iris. In the exemplary embodiment, the identification information reading unit 143 is described as a contactless ID card reader. When a monitor target holds an own ID card over the gate terminal apparatus 14, identification information is read by the identification information reading unit 143.

The identification unit 142 identifies a monitor target based on the read identification information. In a case where the identified monitor target is allowed to enter or exit the monitoring area, the gate control unit 144 controls unlocking of the gates. The control unit 142 and the gate control unit 144 can be configured with a single processor or independent processors.

The state detection apparatus 15 includes a communication unit 151, a state detection unit 152, and a bus 153. The communication unit 151 and the state detection unit 152 are connected to the bus 153. The communication unit 151 is connected to the network 11. The state detection unit 152 detects the state of a monitor target who enters or exits the room. The state detection unit 152 is configured with a load sensor for measuring a weight, an image sensor for acquiring an image, or the like. The communication unit 151 outputs a result detected by the state detection unit 152 to the monitor terminal apparatus 12.

When the load sensor is used as the state detection unit 152, the state comparison unit 125 in the monitor terminal apparatus 12 uses weights of a monitor target to compare states of the monitor target detected at entry and at exit.

When the image sensor is used as the state detection unit 152, the state comparison unit 125 performs, for example, processing for extracting an object held by the monitor target from the images at entry and exit based on motion vectors obtained by referring to images before and after the entry and exit. The object can be extracted by differentiating a region of a shape of a person from a moving region. Then, as comparison processing of the monitor target, whether the object held by the monitor target at entry and exit exists is detected.

That is, whether the state of the monitor target has changed is determined based on whether the object extracted at entry exists at exit, or, whether the object extracted at exit does not exist at entry.

In the case where the image sensor is used as the state detection unit 152, an image captured by the image capture unit 132 can be used.

Hereinafter, the exemplary embodiment that uses the load sensor as the state detection unit 152 is described. The state detection unit 152 is installed in each of the gates G1 to G3.

The passage detection apparatus 16 includes a communication unit 161, a gate passage detection unit 162, and a bus 163. The communication unit 161 and the gate passage detection unit 162 are connected to the bus 163. The communication unit 161 is connected to the network 11. The gate passage detection unit 162 is a sensor for detecting that a monitor target passes through a gate. When the gate passage detection unit 162 detects that a monitor target passes through a gate, the communication unit 161 associates a signal indicating the passage with passage time information, and notifies the monitor terminal apparatus 12 of the associated signal and information.

As the gate passage detection unit 162, a sensor that determines the passage when the monitor target crosses an infrared ray emitted from an infrared sensor, or a device that determines the passage by image processing, can be used. In the case of the detection by the image processing, an image for the image processing can be acquired from the image capturing unit 132, and the function of the gate passage detection unit 162 can be added to the monitor terminal apparatus 12. Hereinafter, description will be made on the assumption that the gate passage detection unit 162 performs the passage detection using the infrared sensor. It is assumed that the gate passage detection unit 162 is installed in each of the gates G1 to G3.

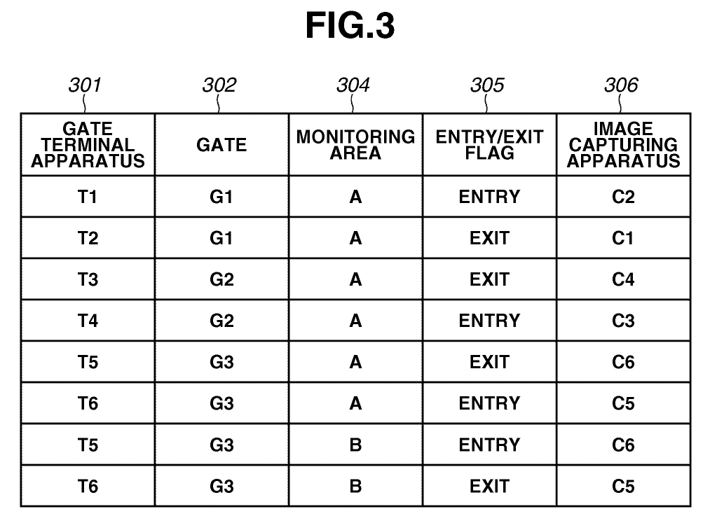

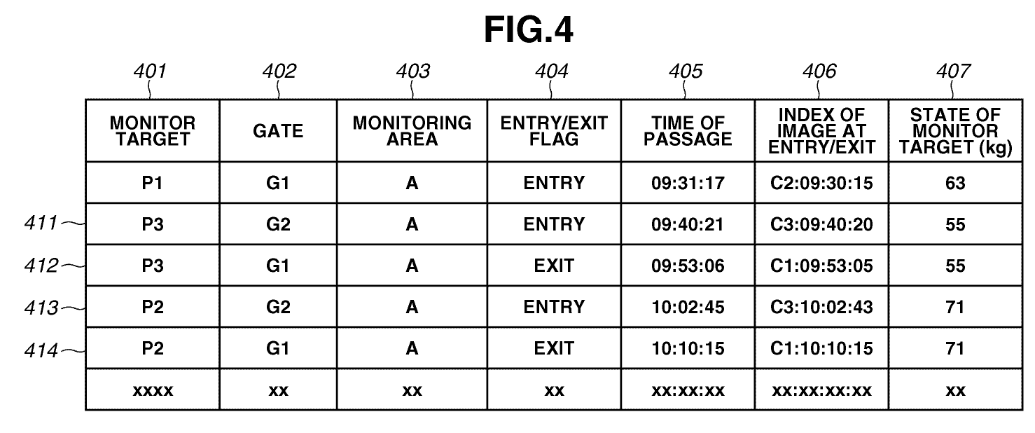

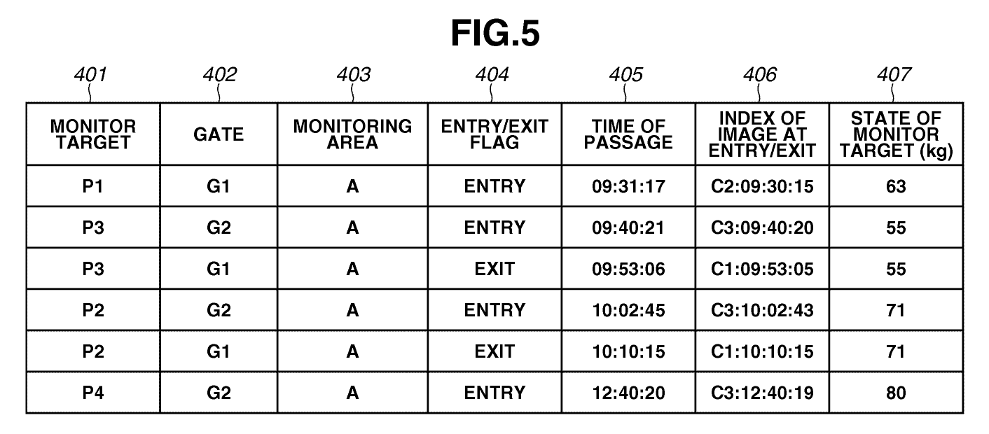

FIG. 3 illustrates an example of management information that includes, as item names, identification information of the gate terminal apparatuses 301, gate identification information 302, monitoring area identification information 304, entry/exit flag information 305, and identification information of the image capturing apparatuses 306. The management information illustrated in FIG. 3 is stored in the hard disk of the storage unit 122 in the monitor terminal apparatus 12. For example, based on the identification information of the gate terminal apparatuses, the monitor terminal apparatus 12 can acquire a gate corresponding to the gate terminal apparatus, identification information of a monitoring area, entry/exit flag information, and an identification name of the image capturing apparatus 13. The acquired information can be used to update management information of entry/exit records illustrated in FIGS. 4 and 5. Hereinafter, the management information illustrates in FIG. 3 is referred to as a management table 1.

FIG. 4 illustrates an example of management information. The management information includes items 401 to 407. More specifically, the management information includes identification information of monitor targets 401, gate identification information 402, monitoring area information 403, entry/exit flag information 404, passage time information 405, index information of images at entry or exit 406, and state information of monitor targets at entry or exit 407. As the item 401, in place of the identification information of monitor targets, identification information (for example, names) of monitor targets identified by the identification unit 142 can be used.

The management information illustrates in FIG. 4 is stored in the hard disk of the storage unit 122 in the monitor terminal apparatus 12. Based on the management information, it is possible to acquire association information between an image of a monitor target at entry or exit and a gate passage record of the monitor target. Hereinafter, the management information is referred to as an entry/exit record and image table.

Updating processing of the entry/exit record and image table illustrated in FIG. 4 is performed, for example, according to the following procedure in the monitor terminal apparatus 12. First, it is assumed that an ID card of a monitor target P4 is read by the gate terminal apparatus T4, and the monitor target P4 enters the monitoring area A through the gate G2. Then, the control unit 124 in the monitor terminal apparatus 12 refers to the management table 1 in FIG. 3, and associates an image at entry captured by the image capturing apparatus C3 corresponding to the gate terminal apparatus T4 with the monitor target P4.

More specifically, the control unit 124 newly adds the identification information (P4) of the monitor target read by the gate terminal apparatus T4 to the item of the monitor targets 401 in the entry/exit record and image table. Then, the control unit 124 refers to the management table 1 in FIG. 3, and associates information about the gate identification information (G2), the monitoring area identification information (A), and the entry/exit flag (entry) corresponding to the gate terminal apparatus T4 with the identification information (P4) of the monitor target.

Further, the control unit 124 associates time information at reception of a signal indicating that the monitor target has passed through the gate from the passage detection apparatus 16 as information of the passage time 405 with the identification information (P4) of the monitor target. In a case where the passage time information is received from the passage detection apparatus 16, the information can be preferentially associated.

Further, the control unit 124 generates index information for acquiring an image at entry or exit. More specifically, the control unit 124 refers to the management table 1 in FIG. 3, and acquires identification information (C3) of the image capturing apparatus corresponding to the gate terminal apparatus T4. The control unit 124 generates index information by adding time information (12:40:19) at the reception of the signal indicating that the monitor target P4 has passed through the gate from the passage detection apparatus 16 to the identification information (C3) of the image capturing apparatus.

The control unit 124 then acquires a state detection result (80 kg) of the monitor target P4 from the state detection apparatus 15 of the gate (G2) corresponding to the gate terminal apparatus T4, and associates the information with the identification information (P4) of the monitor target.

With the above-described processing, the entry/exit record and image table in FIG. 4 is updated as illustrated in FIG. 5. FIG. 5 illustrates an example of an entry/exit record and image table after the monitor target P4 has entered the room.

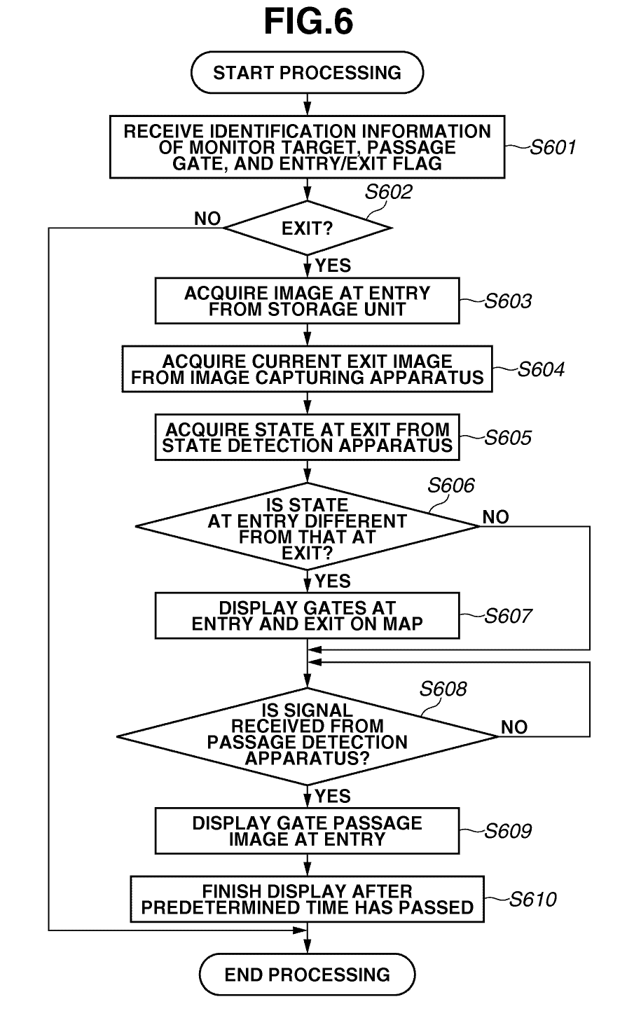

FIG. 6 is a flowchart illustrating operation of a monitoring apparatus according to the first exemplary embodiment of the present invention. FIG. 6 illustrates processing procedure performed by the monitor terminal apparatus 12. More specifically, the flowchart is an operation processing flowchart implemented by performing a computer-readable program by a processor (CPU) that implements the functions of the control unit 124 and the state comparison unit 125.

When an observer gives an instruction to the monitor terminal apparatus 12 to start the processing, the program in the monitor terminal apparatus 12 is loaded into the RAM in the storage unit 122, and predetermined processing is started.

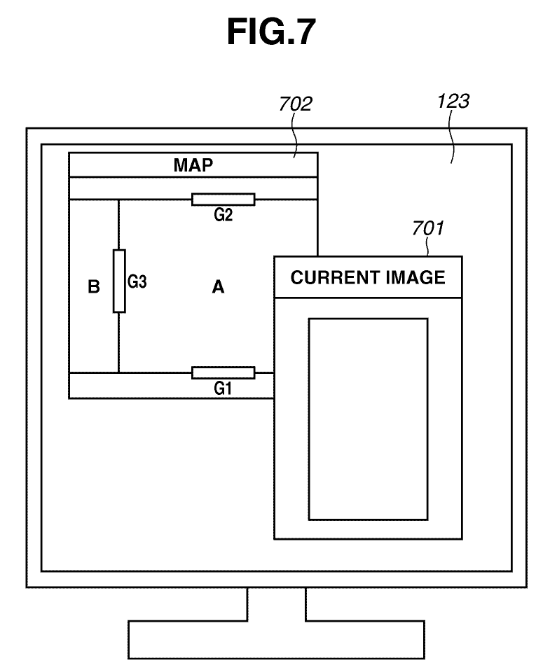

A case where a monitor target P1 exits the room through the gate G3 with an object held in his/her hands is described as a specific example. As a premise in the case, an entry/exit record and image table is in such a state as that illustrated in FIG. 5. Referring to FIG. 5, the monitor target P1 has already entered the monitoring area A through the gate G1. Further, as illustrated in FIG. 7, it is assumed that a current image 701 and a map 702 are displayed on the display unit 123 of the monitor terminal apparatus 12. FIG. 7 is a view illustrating an example of the screen of the display unit 123 displaying the current image and the map.

Referring to FIG. 6, in step S601, the control unit 124 receives identification information, a passage gate, and an entry/exit flag of the monitor target identified by the identification unit 142 from the gate terminal apparatus 14 via the communication unit 121. In the exemplary embodiment, the ID card of the monitor target P1 is read by the gate terminal apparatus T5. Accordingly, the control unit 124 acquires the identification information of the monitor target P1, the passage gate G3 corresponding to the gate terminal apparatus T5, and the entry/exit flag at exit from the gate terminal apparatus T5.

In step S602, based on the information acquired in step S601, the control unit 124 determines whether the monitor target enters or exits the monitoring area. In this case, the monitor target exits the monitoring area A. Accordingly, the processing proceeds to step S603.

In step S603, the control unit 124 searches a recent entry record of the monitor target P1 to the monitoring area A using the entry/exit record and image table stored in the storage unit 122. Then, the control unit 124 reads a gate passage image at entry from the hard disk of the storage unit 122 into the RAM in the storage unit 122 based on the index of the entry/exit image.

In step S604, the control unit 124 identifies the image capturing apparatus 13 that is capturing a current exit image using the management table 1 in the hard disk of the storage unit 122. In step S601, the ID card of the monitor target P1 has already been read by the gate terminal apparatus T5. Accordingly, the control unit 124, referring to the management table 1, determines the identification name of the image capturing apparatus 13 capturing the current image, which is an image at exit, to be C6. Then, the control unit 124 buffers an image captured by the image capturing apparatus 13 (C6) into the RAM in the storage unit 122.

In step S605, the state comparison unit 125 acquires information about a weight of the monitor target P1 as a detection result of state information of the monitor target P1. More specifically, a request signal for state detection is transmitted from the communication unit 121 to the state detection unit 152 in the state detection apparatus 15 of the gate G3. Then, the processing to receive the state detection result is performed. In this case, it is assumed that the state comparison unit 125 receives a weight of 67 kg as the weight of the monitor target P1 as the state detection result from the state detection unit 152.

In step S606, the state comparison unit 125 determines whether the states of the monitor target differ at entry and at exit. More specifically, the state comparison unit 125 compares the weights of the monitor target P1 at entry and at exit. The state comparison unit 125 compares the weight of 67 kg at exit acquired in step S605 with the weight at entry obtained by referring to the entry/exit record and image table stored in the storage unit 122. As a result, the state comparison unit 125 determines that the state of the weight of the monitor target P1 at entry differs from that at exit.

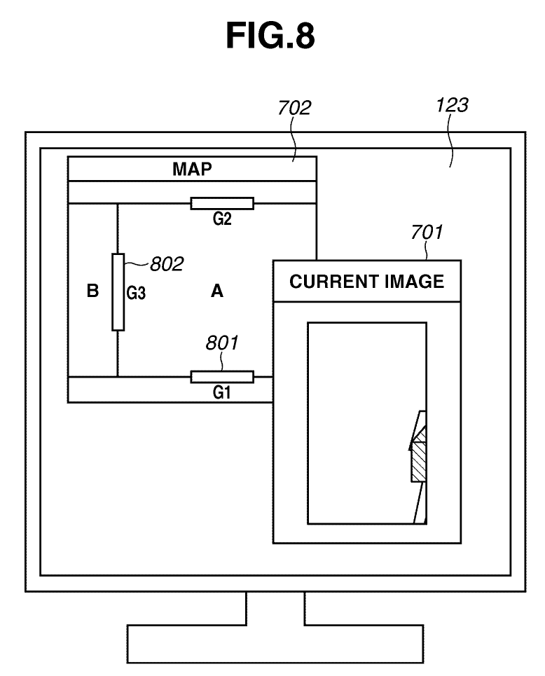

In step S607, the control unit 124 causes the display unit 123 to identify and display a gate position 801 at entry and a gate position 802 at exit, as illustrated in FIG. 8. FIG. 8 illustrates an example of a screen displayed on the display unit 123, on which the map 702, which indicates the gate position 801 at entry and the gate position 802 at exit, and the current image 701 are displayed. If the image display at entry is troublesome, the processing in step S607 can be omitted.

In step S608, the control unit 124 waits for reception of a passage signal transmitted from the passage detection apparatus 16 of the gate G3. When the passage detection unit 162 detects that the monitor target P1 has crossed an infrared ray emitted from the infrared sensor of the gate G3, the passage signal is transmitted from the passage detection apparatus 16 to the monitor terminal apparatus 12. When the passage signal for the monitor target is received, the processing proceeds to step S609.

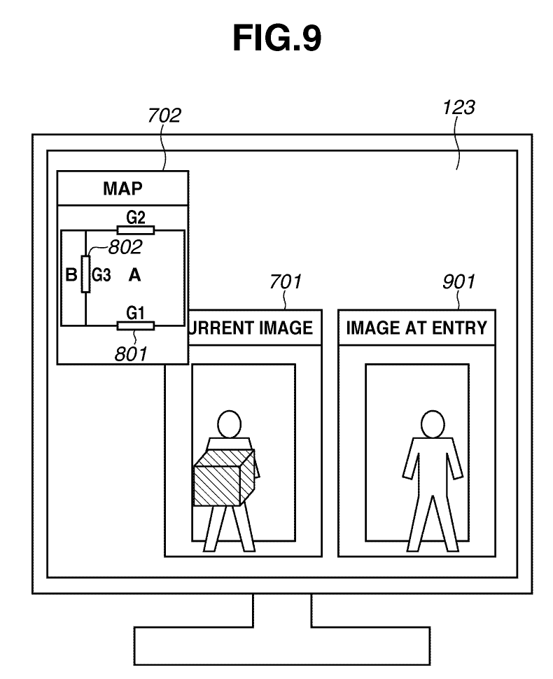

In step S609, the control unit 124 causes the display unit 123 to popup-display the image of the monitor target P1 at entry on a display region 901, as illustrated in FIG. 9, which has been read in the RAM in the storage unit 122 in step S603. That is, the image at entry 901 is juxtaposed to the current image displayed on the region 701. The control unit 124 causes the display unit 123 to display the image at exit being buffered in the RAM in the storage unit 122 in step S604 as the image currently being captured in the region 701. As illustrated in FIG. 9, the image corresponding to the gate passage time at entry and the image corresponding to the gate passage time at exit are displayed at the same time. Accordingly, the monitoring efficiency is increased.

In FIG. 9, in the exemplary embodiment, the image at entry is popup-displayed while being juxtaposed to the current image. However, any display method can be employed without departing from the spirit of the present invention. Further, the image to be displayed in the method can be a moving image or a still image.

In step S610, the control unit 124 controls the display unit 123 such that the display of the image is finished after a predetermined period of time has passed from the time the passage signal has been received in step S608. In a case where a moving image is displayed as the image at entry and the image at entry is finished by the elapse of the predetermined period of time, loop reproduction for repeatedly reproducing the image at entry can be performed.

In the above-described first exemplary embodiment, when the monitor target exits the room, the image at exit, which is the current image, is displayed on the display unit 123. In the description below, as an example, a case where an image captured by the image capturing apparatus 13 (C1) and stored in the hard disk of the storage unit 122 is reproduced and displayed to allow the observer to check the image is described.

For example, an entry/exit record and image table is in a state illustrated in FIG. 4. That is, in the state, a monitor target P3 enters the room through the gate G2 and then exits the room through the gate G1. Further, a monitor target P2 enters the room through the gate G2 and then exits the room through the gate G1.

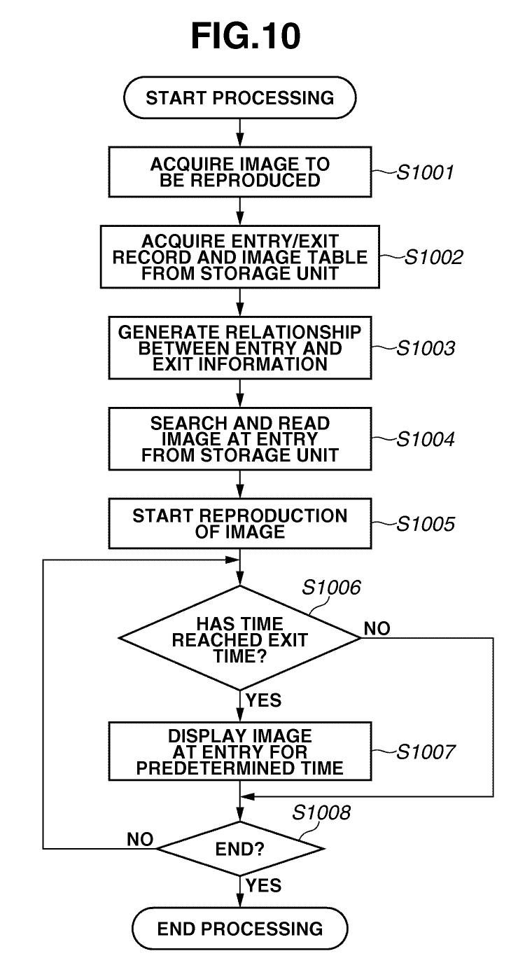

Hereinafter, operation is described with reference to a flowchart illustrated in FIG. 10. FIG. 10 is a flowchart illustrating operation of a monitoring apparatus according to a second exemplary embodiment of the present invention. FIG. 10 illustrates processing procedure performed by the monitor terminal apparatus 12. More specifically, the flowchart is an operation processing flowchart implemented by performing a computer-readable program by a processor (CPU) that implements the functions of the control unit 124 and the state comparison unit 125.

When the observer gives an instruction to start the processing to the monitor terminal apparatus 12, the program in the monitor terminal apparatus 12 is loaded into the RAM in the storage unit 122, and predetermined processing is started.

First, the observer selects an image to be reproduced stored in the hard disk of the storage unit 122 using the input unit 126. Then, in step S1001, the control unit 124 acquires selection information of the image to be reproduced.

For example, when an image captured by the image capturing apparatus 13 (C1) is selected as the image to be reproduced, the control unit 124 reads the data of the image captured by the image capturing apparatus 13 (C1) from the hard disk of the storage unit 122. It is assumed that the input unit 126 is configured with a keyboard and a mouse.

In step S1002, the control unit 124 refers to the entry/exit record and image table illustrated in FIG. 4, which is stored in the storage unit 122.

In step S1003, the control unit 124 generates a relationship between the entry information and the exit information from the entry/exit record and image table, and stores the information in the RAM in the storage unit 122.

More specifically, the control unit 124 refers to the item 406, and searches for an index of the image captured by the image capturing apparatus 13 (C1) at entry and at exit. As a result, records 412 and 414 are found. Then, in the searched records 412 and 414, the control unit 124 refers to the item of the identification information 401 of the monitor target and the item of the entry/exit flag 404. For example, the items 401 and 404 associated with the index “C1:09:53:05” of the image at entry/exit in the record 412 are the monitor target “P3” and the entry/exit flag “exit”.

In such a case, a record immediately before the record 412, which has the items 401 and 404 of the monitor target “P3” and the entry/exit flag “entry”, is searched. (In a case where the entry/exit flag is “entry”, a record immediately after the record 412, which has the entry/exit flag of “exit”, is searched.) As a result, a record 411 is found. Similarly, in the case of the record 414, a record 413 is found.

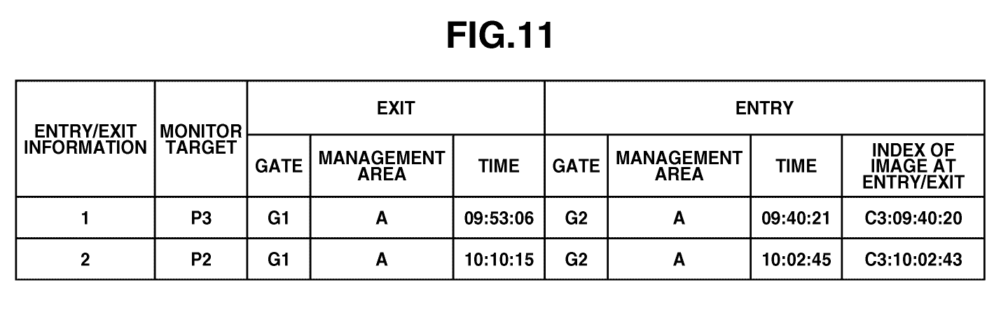

Based on the information of the searched records 411 to 414, relationships (entry/exit table) between entry information and exit information illustrated in FIG. 11 are generated. In the entry/exit information correspondence table illustrated in FIG. 11, indexes of images at entry corresponding to the exit time of monitor targets are associated.

In step S1004, the control unit 124 searches for an image at entry from the storage unit 122 based on the index information of the images at entry or exit obtained by referring to the information of the entry/exit information correspondence table generated in step S1003. Then, the control unit 124 reads the found image at entry in the RAM in the storage unit 122.

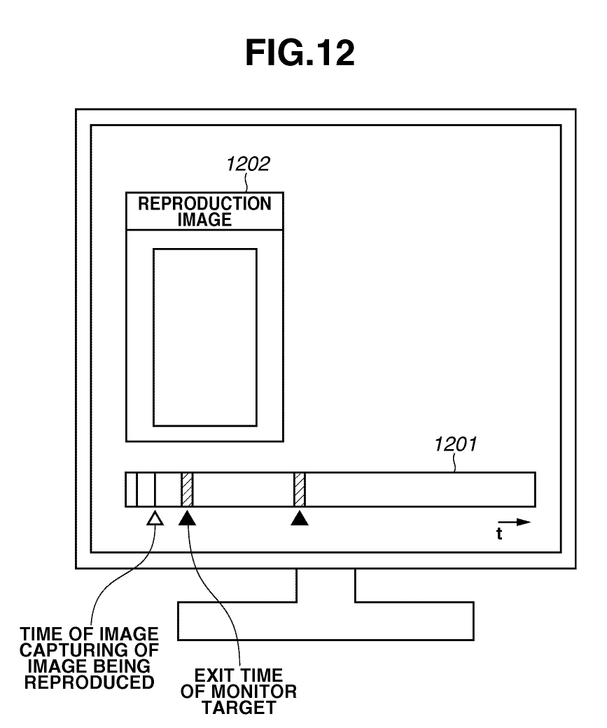

In step S1005, the control unit 124 starts reproduction of the image read in the RAM in the storage unit 122. An example of the screen displayed on the display unit 123 at the reproduction of the image is illustrated in FIG. 12. In FIG. 12, a time line display region 1201 is a display region for indicating time information of an image being reproduced. An image display region 1202 is a region for displaying an image to be reproduced. In the time line display region 1201, a white triangle indicates time of image capturing of the image being reproduced in the image display region 1202. A Black triangle indicates time of exit of the monitor target.

In step S1006, the control unit 124 determines whether reproduction time reaches the exit time in the entry/exit record and image table acquired in step S1002. The determination is made based on comparison between the image capture time information added to the image frame to be reproduced and the entry/exit information correspondence table generated in step S1003. When the reproduction time reaches the exit time, the processing proceeds to step S1007. The processing can proceed to step S1007 before predetermined time immediately before the reproduction time reaches the exit time.

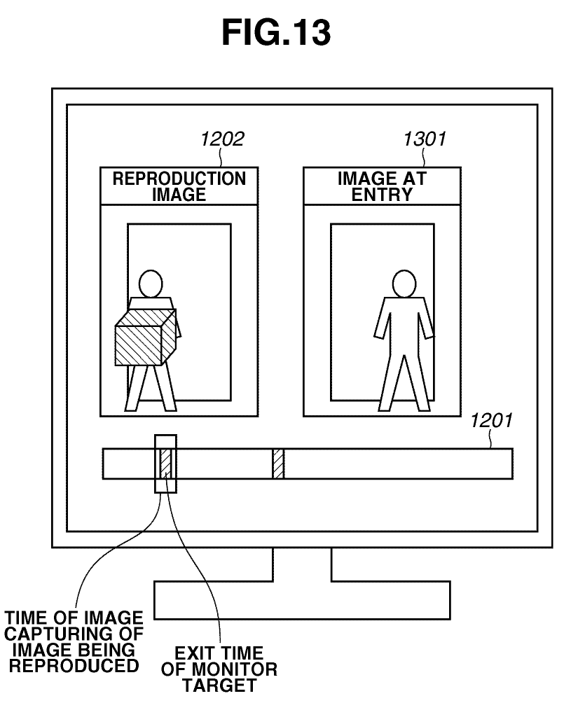

In step S1007, the control unit 124 performs control such that the image at entry read in the RAM in the storage unit 122 is popup-displayed on an image display region 1301 illustrated in FIG. 13, and the region 1301 is arranged next to the image display region 1202 where the image at exit is being displayed. FIG. 13 illustrates an example of a screen on which an image at entry is popup-displayed. In FIG. 13, the image at entry is shown with reference numeral 1301. After a predetermined period of time has passed, the display of the image at entry is finished.

In step S1008, when an instruction to finish the reproduction by the observer is detected, the control unit 124 finishes the reproduction processing of the image being displayed in the image display region 1202.

In the second exemplary embodiment, the reproduction of the image is performed from the beginning. However, only an image near the exit time indicated by the shaded area in the time line display region 1201 in FIG. 12 can be reproduced, so that an image at entry can be checked.

While the present invention has been described with reference to the exemplary embodiment, it is to be understood that the invention is not limited to the disclosed exemplary embodiment. The scope of the following claims is to be accorded the broadest interpretation so as to encompass all modifications, equivalent structures, and functions.

This application claims priority from Japanese Patent Application No. 2008-080847 filed on Mar. 26, 2008, which is hereby incorporated by reference herein in its entirety.

What is claimed is:

1. A monitoring apparatus comprising:
a reception unit configured to receive identification information of a monitor target exiting a room through a gate from a gate terminal apparatus;
an acquisition unit configured to acquire an image of the monitor target captured at entry from a storage unit based on the identification information of the monitor target received by the reception unit; and
a processing unit configured to cause a display unit to display the image of the monitor target at entry acquired by the acquisition unit together with an image of the monitor target at exit transmitted from an image capturing apparatus corresponding to the gate terminal apparatus.

2. The monitoring apparatus according to claim 1, wherein the processing unit causes the display unit to display gate positions through which the monitor target has passed at entry and at exit in a case where states of the monitor target at entry and at exit differ from each other.

3. The monitoring apparatus according to claim 2, wherein the states of the monitor target at entry and at exit include weight of the monitor target or information indicating whether an object held by the monitor target exists.

4. The monitoring apparatus according to claim 1, wherein, in a case where an image capturing apparatus is selected, the processing unit identifies a monitor target image-captured by the selected image capturing apparatus, reads an image of the identified monitor target at entry from the storage unit, and causes the display unit to display the read image.

5. A monitoring apparatus comprising:
a processing unit configured to read an image of a monitor target obtained by an image capturing apparatus from a storage unit and to cause a display unit to reproduce and display the image; and
a determination unit configured to determine whether time of image-capturing of the image being reproduced and displayed reaches exit time of the monitor target,
wherein the processing unit causes the display unit to display an image of the monitor target at entry based on information about an entry/exit record in a case where the time of image-capturing of the image being reproduced and displayed reaches the exit time of the monitor target.

6. A display processing method for a monitoring apparatus, the display processing method comprising:
receiving identification information of a monitor target exiting a room through a gate from a gate terminal apparatus;
acquiring an image of the monitor target at entry from a storage unit based on the identification information; and
causing a display unit to display the image of the monitor target at entry together with an image of the monitor target at exit transmitted from an image capturing apparatus corresponding to the gate terminal apparatus.

7. The display processing method according to claim 6, further comprising causing the display unit to display gate positions through which the monitor target has passed at entry and at exit in a case where states of the monitor target at entry and at exit differ from each other.

8. The display processing method according to claim 7, wherein the states of the monitor target at entry and at exit includes weight of the monitor target or information indicating whether an object held by the monitor target exists.

9. The display processing method according to claim 6, further comprising, in a case where an image capturing apparatus is selected, identifying a monitor target image-captured by the selected image capturing apparatus, reading an image of the identified monitor target at entry from the storage unit, and causing the display unit to display the read image.

10. A display processing method for a monitoring apparatus, the display processing method comprising:
reading an image of a monitor target obtained by an image capturing apparatus from a storage unit and causing a display unit to reproduce and display the image; and
causing the display unit to display an image of the monitor target at entry based on information about an entry/exit record in a case where time of image-capturing of the image being reproduced and displayed reaches exit time of the monitor target.

11. A computer-readable storage medium containing computer-executable instructions for controlling a monitoring apparatus, the medium comprising:
computer-executable instructions that receive identification information of a monitor target exiting a room through a gate from a gate terminal apparatus;
computer-executable instructions that acquire an image of the monitor target captured at entry from a storage unit based on the received identification information of the monitor target; and
computer-executable instructions that cause a display unit to display the acquired image of the monitor target at entry together with an image of the monitor target at exit transmitted from an image capturing apparatus corresponding to the gate terminal apparatus.

12. The computer-readable storage medium according to claim 11, further comprising computer-executable instructions that cause the display unit to display gate positions through which the monitor target has passed at entry and at exit in a case where states of the monitor target at entry and at exit differ from each other.

13. The computer-readable storage medium according to claim 11, further comprising computer-executable instructions that, in a case where an image capturing apparatus is selected, identify a monitor target image-captured by the selected image capturing apparatus, read an image of the identified monitor target at entry from the storage unit, and cause the display unit to display the read image.

14. A computer-readable storage medium containing computer-executable instructions for controlling a monitoring apparatus, the medium comprising:
computer-executable instructions that read an image of a monitor target obtained by an image capturing apparatus from a storage unit and causing a display unit to reproduce and display the image; and
computer-executable instructions that cause the display unit to display an image of the monitor target at entry based on information about an entry/exit record in a case where time of image-capturing of the image being reproduced and displayed reaches exit time of the monitor target.
